(19) United States
(12) Patent Application Publication
(10) Pub. No.: US 2018/0376034 A1
(43) Pub. Date: Dec. 27, 2018

(54) ATOMIC CLOCK BASED SYNCHRONIZATION FOR IMAGE DEVICES

(71) Applicant: CHRISTIE DIGITAL SYSTEMS USA, INC., Cypress, CA (US)

(72) Inventors: Roy ANTHONY, Waterloo (CA); Gary KLASSEN, Waterloo (CA)

(21) Appl. No.: 16/015,261

(22) Filed: Jun. 22, 2018

Related U.S. Application Data
(60) Provisional application No. 62/523,282, filed on Jun. 22, 2017.

(51) Int. Cl. H04N 5/04; G09G 5/12; G04F 5/14

(52) U.S. Cl. CPC H04N 5/04; G04F 5/14; G09G 5/12

(57) ABSTRACT

A device and method for atomic clock based synchronization for image devices is provided. An image device provided herein includes: an image component configured to one of provide or acquire images; an atomic accuracy clock synchronizable with an atomic clock; an interface configured to receive data indicative of one or more times for one of providing or acquiring the images; and a controller. The controller is configured to control the image component to provide or acquire the images at the one or more times synchronized with the atomic accuracy clock.

### FIELD

The specification relates generally to image devices, and specifically to a device and method for atomic clock based synchronization for image devices.

### BACKGROUND

Massive pixelscapes are generated through overlapped and abutted displays and display technologies, including, for example, projectors, achieving high resolution. These display technologies are often driven by remote clustered, or co-located and networked display image generators to distribute and synchronize content. These systems rely on hardwired infrastructure (e.g. all the displays are hardwired to image generators and sometimes each other), and specialized graphics generation and display hardware to synchronize the image generation, the distribution pipeline and the onscreen image rasterization. In some instances, wireless network based signalling, such as WiFi and the like, may be used to coordinate the displays, however such wireless network based signalling may be too slow to adequately synchronize the displays: human beings are extremely sensitive to even small defects in displayed images, hence one image being out of synchronization with an adjacent displayed image by even a small amount of time can be noticeable to at least some humans. Similarly, when images are being captured from multiple angles by cameras and/or video cameras and/or cinema-quality digital movie cameras, and the like, they can be coordinated using hardwired infrastructure or wireless signals, which has the same disadvantages as when coordinating display devices.

### SUMMARY

In general, this disclosure is directed to an image device which includes an atomic accuracy clock which is synchronizable with an atomic clock. In some example implementations, the atomic accuracy clock is a component of a satellite-based location determining device (e.g. a GPS (Global Positioning System) device and/or a GLONASS (Globalnaya Navigazionnaya Sputnikovaya Sistema) device) incorporated into the image device, and the atomic accuracy clock is synchronized with the atomic clock located at satellites with which the satellite-based location determining device is communicating.

In some implementations, the image device comprises a display device and/or image generation hardware, including, but not limited to, a flat panel display, a projector and the like, used, for example, in a system of similar display devices which are in turn being used to tile images (e.g. by either abutting the display devices or projecting images, depending on the technology od the display device). Data representing the images to be provided is received at the display device, the data comprising frames and/or subframes to be provided with at least a time that providing the frames and/or subframes is to start; in some of these implementations, the data comprises subframes of the images and respective times at which each of the subframes is to be provided. A controller at the display device controls the display device to provide the images at the time(s) in the data synchronized with the atomic accuracy clock. Presuming all the atomic accuracy clocks at each of the display devices being used to tile images are synchronized with the atomic clock, then all the display devices provide their respective images in a coordinated fashion without using coordinating signals from hardware connections and/or slow wireless connections.

In some implementations, the image device comprises one or more of a camera, a video camera and a cinema-quality digital movie camera, and data received at the image devices is indicative of one or more times for acquiring images. In these implementations, the camera, video camera and/or cinema-quality digital movie camera acquire images at the received time(s) in a coordinated fashion with any other similar cameras, video cameras and cinema-quality digital movie cameras without using hardware connections and/or slow wireless connections.

In some of these implementations, the satellite-based location determining device is a mobile device, for example incorporated into a USB (Universal Serial Bus) dongle, and the like, and the satellite-based location determining device is received at a hardware port of the image device, such as a USB port. Hence, when an image device comprises such a hardware port, the image device is adaptable to be used with the techniques described herein without any further change in the hardware of the image device.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

Another aspect of the specification provides an image device comprising: an image component configured to one of provide or acquire images; an atomic accuracy clock synchronizable with an atomic clock; an interface configured to receive data indicative of one or more times for one of providing or acquiring the images; and a controller configured to control the image component to provide or acquire the images at the one or more times synchronized with the atomic accuracy clock.

In some implementations, the image component comprises one or more of a display device and a projector configured to provide the images; the data further comprises the images to be provided, and one or more times for providing the images; and the controller is further configured to control the image component to provide the images at the one or more times synchronized with the atomic accuracy clock. In some implementations, the images to be provided comprise one or more of frames and subframes, and the one or more times comprises one or more of frame times and subframe times at which respective frames and subframes are to be provided, synchronized with the atomic accuracy clock.

In some implementations, the image component comprises one or more of a camera, a video camera, and a cinema-quality digital movie camera configured to acquire the images; and the controller is further configured to control the image component to acquire the images at the one or more times synchronized with the atomic accuracy clock.

In some implementations, the image device further comprises a location determining device comprising the atomic accuracy clock, the location determining device configured to: communicate with one or more location-determining satellites comprising the atomic clock; and synchronize the atomic accuracy clock with the atomic clock. In some implementations, the location determining device comprises one or more of a satellite-based location determining device, a GPS (Global Positioning System) device and a GLONASS (Globalnaya Navigazionnaya Sputnikovaya Sistema) device.

In some implementations, the image device further comprises: a mobile satellite-based location determining device; and a hardware port configured to removably receive the mobile satellite-based location determining device, the mobile satellite-based location determining device comprising the atomic accuracy clock.

Another aspect of the specification provides a method comprising: at an image device comprising: an image component configured to one of provide or acquire images; an atomic accuracy clock synchronizable with an atomic clock; an interface configured to receive data indicative of one or more times for one of providing or acquiring the images; and a controller, receiving, at the controller, using the interface, the data indicative of the one or more times for one of providing or acquiring the images; and controlling, using the controller, the image component to provide or acquire the images at the one or more times synchronized with the atomic accuracy clock.

In some implementations, the image component comprises one or more of a display device and a projector configured to provide the images; the data further comprises the images to be provided, and one or more times for providing the images; and the method further comprises controlling, at the controller, the image component to provide the images at the one or more times synchronized with the atomic accuracy clock. In some implementations, the images to be provided comprise one or more of frames and subframes, and the one or more times comprises one or more of frame times and subframe times at which respective frames and subframes are to be provided, synchronized with the atomic accuracy clock.

In some implementations, the image component comprises one or more of a camera, a video camera, and a cinema-quality digital movie camera configured to acquire the images; and the method further comprises controlling, at the controller, the image component to acquire the images at the one or more times synchronized with the atomic accuracy clock.

In some implementations, the image device further comprises a location determining device comprising the atomic accuracy clock, the location determining device configured to: communicate with one or more location-determining satellites comprising the atomic clock; and synchronize the atomic accuracy clock with the atomic clock. In some implementations, the location determining device comprises one or more of a satellite-based location determining device, a GPS (Global Positioning System) device and a GLONASS (Globalnaya Navigazionnaya Sputnikovaya Sistema) device.

In some implementations, the image device further comprises: a mobile satellite-based location determining device; and a hardware port configured to removably receive the mobile satellite-based location determining device, the mobile satellite-based location determining device comprising the atomic accuracy clock.

Another aspect of the specification provides a non-transitory computer-readable medium storing a computer program, wherein execution of the computer program is for: at an image device comprising: an image component configured to one of provide or acquire images; an atomic accuracy clock synchronizable with an atomic clock; an interface configured to receive data indicative of one or more times for one of providing or acquiring the images; and a controller, receiving, at the controller, using the interface, the data indicative of the one or more times for one of providing or acquiring the images; and controlling, using the controller, the image component to provide or acquire the images at the one or more times synchronized with the atomic accuracy clock.

### BRIEF DESCRIPTIONS OF THE DRAWINGS

For a better understanding of the various implementations described herein and to show more clearly how they may be carried into effect, reference will now be made, by way of example only, to the accompanying drawings in which:

FIG. 1 depicts an image device for atomic clock based synchronization of providing or acquiring images, according to non-limiting implementations.

FIG. 2 depicts flowchart of method for atomic clock based synchronization of providing or acquiring images, according to non-limiting implementations.

FIG. 3 depicts a system with a plurality of projectors, each configured for atomic clock based synchronization projecting of images, according to non-limiting implementations.

FIG. 4 depicts the system of FIG. 3, with the plurality of projectors projecting images according to atomic clock based synchronization, according to non-limiting implementations.

FIG. 5 depicts a system with a plurality of cameras, each configured for atomic clock based synchronization acquiring of images, according to non-limiting implementations.

### DETAILED DESCRIPTION

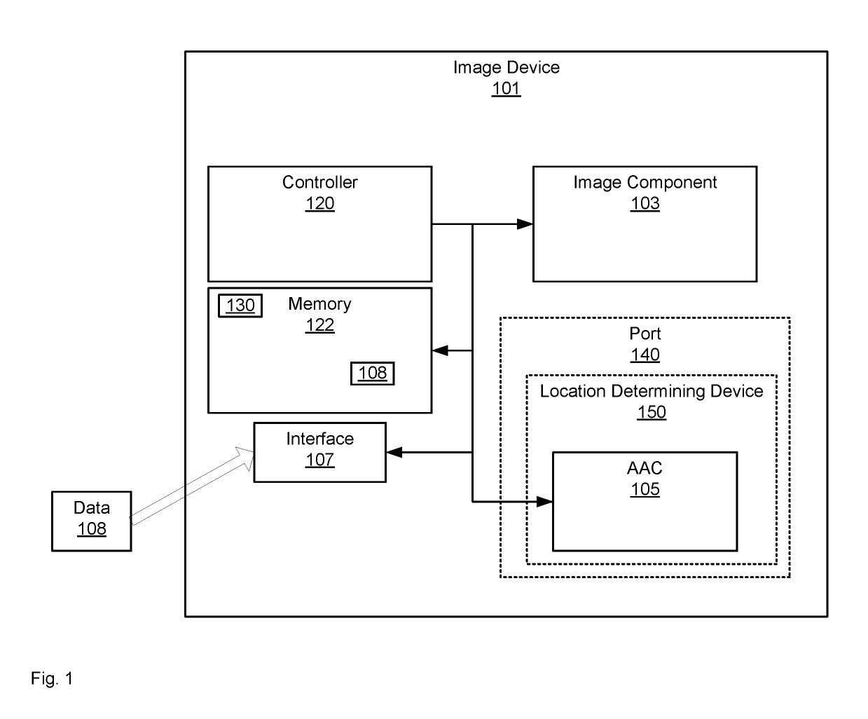

FIG. 1 depicts an image device 101 comprising: an image component 103 configured to one of provide or acquire images; an atomic accuracy clock (AAC) 105 synchronizable with an atomic clock; an interface 107 configured to receive data 108 indicative of one or more times for one of providing or acquiring the images; and a controller 120 configured to control the image component 103 to provide or acquire the images at the one or more times synchronized with the AAC 105.

As depicted, the image device 101, interchangeably referred to hereafter as the device 101, further comprises a memory 122 which can store the data 108 when received (as depicted), and an application 130 used to control the device 101.

In general, the controller 120 is interconnected with the other components of the device 101 using, for example, a computer bus and the like.

As depicted, the device 101 comprises an optional hardware port 140, which can comprise one or more of a USB (Universal Serial Bus) port, a serial port, a parallel port, and the like, and the AAC 105 is component of a location determining device 150 (interchangeably referred to as the LD device 150), removably received at the hardware port 140. In these implementations, the LD device 150 comprises a removeable dongle and/or key receivable at the hardware port 140 which is compatible with the architecture of the hardware port 140. For example, when the hardware port 140 comprises a USB port, the removeable dongle and/or key comprises a USB dongle and/or key; when the hardware port 140 comprises a serial port, the removeable dongle and/or key comprises a serial-port compatible dongle and/or key; and when the hardware port 140 comprises a parallel port, the removeable dongle and/or key comprises a parallel-port compatible dongle and/or key.

As both the hardware port 140 and the LD device 150 are optional, they are depicted in stippled lines. Furthermore, in some implementations, the AAC 105 and/or the LD device 150 are non-removeable components of the device 101. In yet further implementations, the AAC 105 is provided at the device 101 as a non-removeable component of the device 101 without the LD device 150 (e.g. the device 101 does not include the LD device 150).

The LD device 150 is generally configured to: communicate with one or more location-determining satellites comprising an atomic clock with which the AAC 105 is synchronized (e.g the atomic clock with which the AAC 105 is synchronized can comprise a remote atomic clock); and synchronize the AAC 105 with the atomic clock. Such communication with the location-determining satellites that results in such synchronization can be carried out by the LD device 150 as part of its periodic determination of a location of the LD device 150, for example as a function of the location-determining functionality of the LD device 150.

Hence, the LD device 150 comprises one or more of a satellite-based location determining device, a GPS (Global Positioning System) device and a GLONASS (Globalnaya Navigazionnaya Sputnikovaya Sistema) device. Such GPS and/or GLONASS devices generally communicate with GPS and/or GLONASS satellites to determine its location, each of such satellites including a respective atomic clock, which are all synchronized to the same time, within atomic accuracy. Hence, the LD device 150 generally synchronizes the AAC 105 to the time of the atomic clock of the GPS and/or GLONASS satellites, and the AAC 105 maintains the time at the device 101 to atomic accuracy. Furthermore, the LD device 150 can periodically updates the time based on communications with the satellites, for example in a periodic determination of the location of the LD device 150.

Indeed, the AAC 105 comprises a clock which maintains a time to atomic accuracy and such atomic accuracy clocks are normal components of GPS devices and GLONASS devices. Indeed, such atomic accuracy clocks are relatively low cost components of a GPS device and/or a GLONASS device, and which are furthermore different from an atomic clock, which is a much higher cost component that is generally integrated into GPS and/or GLONASS satellites. For example, an atomic clock is generally part of a network of atomic clocks which are intercompared and kept synchronized, for example by national standards agencies; an atomic accuracy clock is similar to an atomic clock, however atomic accuracy clocks simply maintain a time to an atomic accuracy, but are not intercompared, nor kept synchronized by national standards agencies. Hence, an atomic accuracy clock is a lower cost component than an atomic clock. Nonetheless, an atomic accuracy clock is a component of a GPS and/or GLONASS device may be synchronized to an atomic accuracy clock that is a component of a GPS and/or GLONASS satellite.

Indeed, as described herein, images devices described herein generally leverage the low cost of an atomic accuracy clock to synchronize image generation and/or acquisition therebetween, by taking advantage of the synchronization of such low-cost atomic accuracy clocks to the much higher cost atomic clocks at GPS satellites and/or GLONASS satellites that can occur during operation of a location determining device into which the atomic accuracy clock is integrated.

Furthermore, when the LD device 150 is removeable, the device 101 comprises a mobile satellite-based LD device 150; and the hardware port 140 configured to removably receive the satellite-based LD device 150, the satellite-based LD device 150 comprising the atomic accuracy clock 105.

Hence, when the device 101 includes the hardware port 140 which can receive the LD device 150, which in turn comprises a GPS device and/or a GLONASS device that includes an atomic accuracy clock, the device 101 is adaptable to operate according to the techniques described herein by inserting a GPS device and/or GLONASS device at the hardware port 140, and by configuring and/or provisioning the memory 122 with the application 130.

The term image device as used herein can refer to either a device which provides images (such as image generation hardware, a display device (e.g. a flat panel display and the like), a projector, and the like) or a device which acquires images (such as a camera, a video camera, and a cinema-quality digital movie camera and the like).

Hence, in some implementations, the device 101 comprises one or more of a display device and a projector (e.g. display hardware and/or image generation hardware) configured to provide the images and/or render content; the data 108 further comprises the images to be provided (and/or content to be rendered), and one or more times for providing the images; and the controller 120 is further configured to control the image component 103 to provide the images at the one or more times synchronized with the AAC 105. Indeed, in these implementations, the image component 103 comprises a display (including but not limited to, any suitable one of, or combination of, flat panel displays (e.g. LCD (liquid crystal display), plasma displays, OLED (organic light emitting diode) displays, capacitive or resistive touchscreens, CRTs (cathode ray tubes) and the like)) and/or an image modulator and projection optics (including but not limited to, any suitable one of, or combination of, a DMD (digital micromirror device), an LCOS (Liquid Crystal on Silicon) device) and the like).

Furthermore, when the device 101 comprises one or more of a display device and a projector, the data 108 comprises the images to be provided, and one or more times for providing the images. For example, the images to be provided can comprise video and/or another other content that can be provided at image generation hardware (e.g. using rasterization and/or any other suitable image generation technique).

In some example implementations, the images are provided in the data 108 as one or more of frames and subframes (e.g. the images can comprise video data), and the one or more times are provided in the data as one or more of frame times and subframe times at which respective frames and subframes are to be provided, synchronized with the AAC 105. For example, the data 108 can be provided as shown below in Table 1, and/or in any format which provides frames and/or subframes and frame times and/or subframe times at which respective frames and/or subframes are to be provided (e.g. a video format, database format, and the like):

TABLE 1

| Subframe | Subframe Time |
|---|---|
| SF1 | T1 (e.g. 16:00:00.00, EST, on 12/24/2017) |
| SF2 | T2 (e.g. 16:00:00.01, EST, on 12/23/2017) |
| SF3 | T3 (e.g. 16:00:00.02, EST, on 12/23/2017) |
| . . . | . . . |

As shown, Table 1 comprises rows and columns, with a header on each column, and with each row corresponding to data representative of a subframe of an image to be provided (e.g. rendered at a display device, or projected at a projector), as indicated by SF1, SF2, SF3, . . . , and a respective time at which the corresponding subframe is to be provided (e.g. T1, T2, T3 . . . ) which, as depicted, is provided as an absolute time (e.g. a specific time on a specific date, according to Eastern Standard Time (EST). Hence, for example, subframe SF1 is to be provided at time T1, subframe SF2 is to be provided at time T2, etc. Furthermore, each subframe can be in an image data format compatible with the image component 103; for example, when the image component 103 includes a DMD, and the like (e.g. the device 101 comprises a projector), each subframe comprises data compatible with a DMD; similarly, when the image component 103 includes a flat panel display image component (e.g. the device 101 comprises a flat panel display), each subframe comprises data compatible with a flat panel display image component.

While the example data 108 of Table 1 is provided in the form of subframes (e.g. portions of a frame that are rendered and/or projected in a sequence as part of a frame), in other implementations, the data 108 comprises frames, and/or images to be provided in a sequence, for example as video. Indeed, a number of subframes, and the like, provided in the data 108 generally depends on a length of the video to be provided.

Furthermore, in some implementations, the data 108 indicates that the images are to be provided in a loop (e.g. a flag, and the like, is provided in the data 108 indicative that the images are to be looped). On these implementations, the device 101 is configured to re-provide the images when the end of the images provided in the data 108 is reached, and the device 101 can recalculate the time associated with each subframe, for example by adding a fixed time to each of the times, T1, T2, T3 . . . . Such a fixed time is generally greater than or equal to a total time for providing all the images in the data 108.

Furthermore, while each of the subframes of the example data 108 of Table 1 is provided with a respective time, in other implementations, the data 108 comprises only a time at which providing the images is to start. In yet further implementations, only a portion of the subframes is provided with a respective time, such that the device 101 synchronizes providing the images periodically (e.g. every m^{th} frame, where “m” is an integer, is provided at a given time). Alternatively, the data 108 comprises a time that each frame is to be provided (e.g. as a frame time), for example as associated with only the first subframe of each frame.

Each of the times in the example data 108 of Table 1 is provided as an absolute time (e.g. a given time, in a given time zone at a given date), and as apparent from Table 1, each successive frame is to be provided every 0.01 seconds, beginning at 16:00 EST (e.g. 4 pm, Eastern Standard Time) on Dec. 24, 2017, however the time difference of 0.01 seconds is provided merely as an example, and the time at which each subframe is to be provided is generally compatible with a frame rate from which the subframes were generated, and a number of subframes in each frame. For example, when the frame rate of the images to be provided is 24 fps (frames per second), with 10 subframes per frame, the time at which each subframe is to be provided is determined from these specific values.

Furthermore, while the time in the example data 108 of Table 1 is provided as an absolute time, the time provided is generally synchronized to the atomic clock with which the AAC 105 is synchronized, regardless of whether that atomic clock is providing an absolute time.

Alternatively, the data 108 comprises data for generating the images, for example in real-time, as well as one or more times for providing the images, such that the controller 120 can generate the images, as well as control the image component 103 to provide the images at the one or more times in the data 108. For example, the data 108 can include times that subframes of video, and the like, are to be provided, as well as data for generating the subframes in real-time rather than the images themselves, for example an algorithm for generating the images and/or subframes and/or data used by the controller 120 to generate the images and/or subframes.

In other implementations, the device 101 comprises one or more of a camera, a video camera, and a cinema-quality digital movie camera configured to acquire the images; and the controller 120 is further configured to control the image component 103 to acquire the images at the one or more times synchronized with the AAC 105. Hence, in these implementations, the image component 103 comprises a CCD (charge coupled device) and the like, configured to digitally acquire images, as well as optics for focussing light forming the images onto the CCD, and the like. In some of these implementations, the data 108 comprises a time at which acquiring images is to start and, optionally, a time at which acquiring images to end. The times in the data 108, in these implementations, are generally synchronized to the atomic clock with which the AAC 105 is synchronized.

The controller 120 comprises a processor and/or a plurality of processors, including but not limited to one or more central processors (CPUs) and/or one or more processing units; either way, the controller 120 comprises a hardware element and/or a hardware processor. Indeed, in some implementations, the controller 120 can comprise an ASIC (application-specific integrated circuit) and/or an FPGA (field-programmable gate array) specifically configured for atomic clock based synchronization of providing or acquiring images. Hence, the device 101 is preferably not a generic display device, projector, or camera device, and the like, but a device specifically configured to implement specific atomic clock based synchronization functionality for providing or acquiring images. For example, the device 101 and/or the controller 120 can specifically comprise a computer executable engine configured to implement specific atomic clock based synchronization functionality for providing or acquiring images.

The memory 122 can comprise a non-volatile storage unit (e.g. Erasable Electronic Programmable Read Only Memory (“EEPROM”), Flash Memory) and a volatile storage unit (e.g. random access memory (“RAM”)). Programming instructions that implement the functional teachings of the device 101 as described herein are typically maintained, persistently, in the memory 122 and used by the controller 120 which makes appropriate utilization of volatile storage during the execution of such programming instructions. Those skilled in the art recognize that the memory 122 is an example of computer readable media that can store programming instructions executable on the controller 120. Furthermore, the memory 122 is also an example of a memory unit and/or memory module and/or a non-volatile memory.

In particular, the memory 122 stores the application 130 that, when processed by the controller 120, enables the controller 120 and/or the device 101 to: receive the data 108 indicative of one or more times for one of providing or acquiring images; and control the image component 103 to provide or acquire the images at the one or more times synchronized with the AAC 105.

The interface 107 comprises any device configured to receive the data 108, wirelessly and/or in a wired configuration. For example, in some implementations, the interface 107 comprises the hardware port 140 which can comprise a USB (universal serial bus) port and the like; in these implementations, the data 108 is provided in a removable mobile memory dongle (e.g. a USB memory key) and received at the hardware port 140.

When the AAC 105 and/or the LD device 150 is a separate component of the device 101, the removable memory dongle can remain in the hardware port 140 during operation of the device 101, and the data 108 is stored at the removable memory dongle rather than the memory 122. However, when the AAC 105 and/or the LD device 150 are also components of a removable dongle, the removable memory dongle is received at the hardware port 140, the data 108 is copied to the memory 122, and the removable memory dongle is replaced at the hardware port 140 with the removable dongle that includes the AAC 105 and/or the LD device 150.

In other implementations, the interface 107 comprises a human-machine interface, including any suitable combination of keyboard, a touchpad, and the like, and the data 108 (e.g. a time at which providing images or acquiring images is to start) is manually input to the memory 122.

In yet further implementations, the interface 107 comprises a wired or wireless network interface including, but not limited to, any suitable combination of a second hardware port (e.g. a USB port a serial port, a parallel port), USB cables, serial cables, a wireless radio, a cell-phone radio, a cellular network radio, a BluetoothTM radio, a NFC (near field communication) radio, a WLAN (wireless local area network) radio, a WiFi link radio, a WiMax radio, a packet based interface, an Internet-compatible interface, an analog interface, a PSTN (public switched telephone network) compatible interface, and the like, and/or a combination. For example, when the device 101 comprise a display device, and the like, images can be received wirelessly over a WiFi radio, and a time to begin providing the images can be received at a keyboard, touchpad, and the like. Hence, in some implementations, the interface 107 comprises a combination of a wireless radio and human-machine interface.

While not depicted, device 101 further comprises a power source, for example a connection to a mains power supply and a power adaptor (e.g. an AC-to-DC (alternating current to direct current) adaptor, and the like). In some implementations, the power source comprises a battery, a power pack, and the like.

In any event, it should be understood that a wide variety of configurations for device 101 are contemplated.

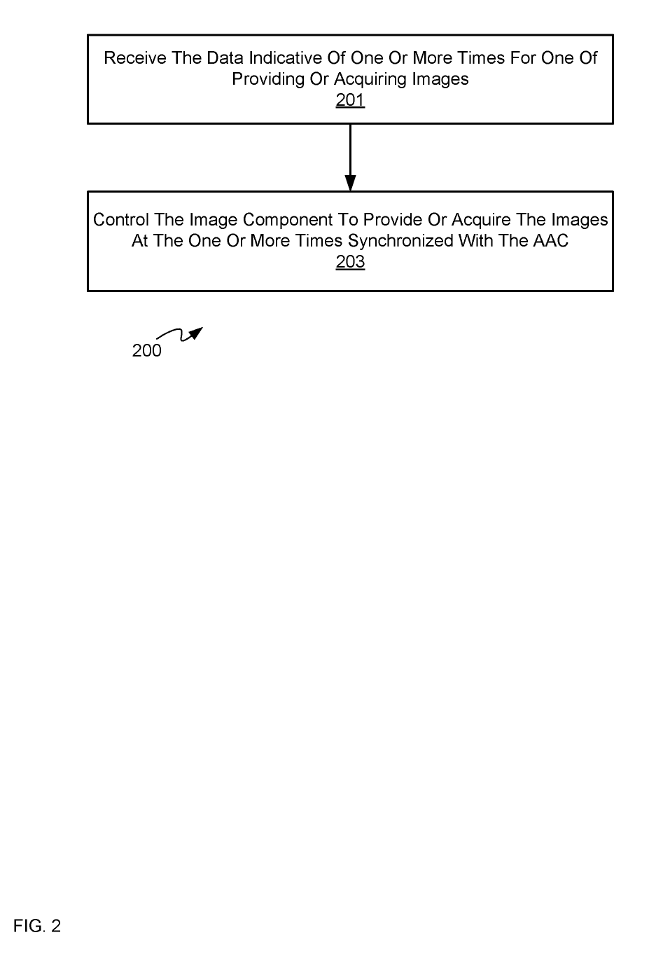

Attention is now directed to FIG. 2, which depicts a flowchart of a method 200 for atomic clock based synchronization, according to non-limiting implementations. In order to assist in the explanation of the method 200, it will be assumed that the method 200 is performed using the controller 120 of the device 101, for example when the controller 120 processes application 130. Indeed, the method 200 is one way in which the device 101 can be configured. Furthermore, the following discussion of the method 200 will lead to a further understanding of the device 101 and its various components. However, it is to be understood that the device 101 and/or the method 200 can be varied, and need not work exactly as discussed herein in conjunction with each other, and that such variations are within the scope of present implementations.

Regardless, it is to be emphasized, that the method 200 need not be performed in the exact sequence as shown, unless otherwise indicated; and likewise various blocks may be performed in parallel rather than in sequence; hence the elements of the method 200 are referred to herein as “blocks” rather than “steps”. It is also to be understood, however, that the method 200 can be implemented on variations of the device 101 as well. Furthermore, while computing the device 101 is described as implementing and/or performing each block of the method 200, it is appreciated that each block of the method 200 occurs using the controller 120 processing the application 130.

At block 201, the controller 120, receive the data 108 indicative of one or more times for one of providing or acquiring images.

At the block 203, the controller 120 controls the image component 103 to provide or acquire the images at the one or more times synchronized with the AAC 105.

Non-limiting examples of the device 101 and the method 200 will now be described.

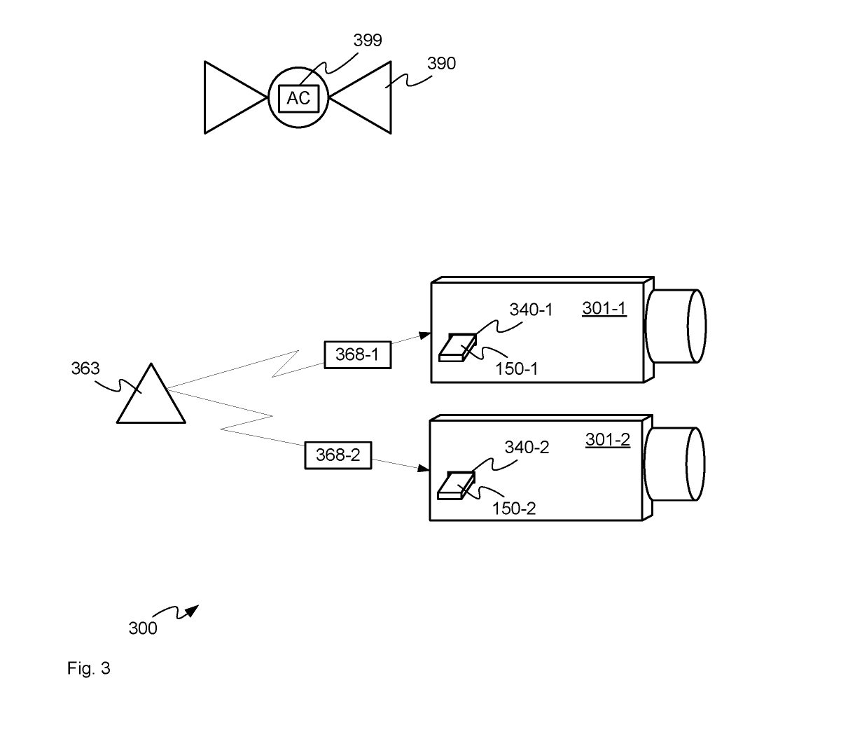

Indeed, attention is next directed to FIG. 3, which depicts a system 300 comprising two projectors 301-1, 301-2 (collectively referred to, hereafter as the projectors 301, and generically as a projector 301), each similar to device 101, assuming that the image component 103 comprises an projector image component, as described above. Hence, each of the projectors 301 includes a controller (not depicted) similar to controller 120 which is executing an application similar to application 130, and hence each of the projectors 301 is implementing the method 200. It is assumed in the system 300 that the projectors 301 are arranged to project tiled images onto an object (not depicted), such a screen and the like.

It is further assumed that each of the two projectors 301 comprise a respective hardware port 340-1, 340-2 (collectively referred to, hereafter as the ports 340, and generically as a port 340), each similar to the hardware port 140. For example, each of the ports 340 can comprise a USB port. At each of the ports 340, each projector 340 has received therein a respective LD device 150 as described above, which includes a respective AAC 105 (not depicted, but assumed to be at each of respective LD device 150). While other internal components of the projectors 301 are not depicted, they are nonetheless assumed to be present.

Indeed, as depicted, the system 300 further comprises an access point 363, for example a WiFi access point, and the like, which provides access to a network (not depicted); it is assumed that each projector 301 is configured to communicate with the access point 363 (e.g. the interface 107 comprises a WiFi radio), to receive respective data 368-1, 368-2 (collectively referred to, hereafter as the data 368, and generically as a set of data 368 and/or the data 368), as indicated in FIG. 3 by the access point 363 transmitting the respective data 368 to each of the projectors 301 (e.g. at the block 201 of the method 200). For example, in the data 368 can be transmitted upon request from each of the projector 301 and/or the data 368 can be pushed to each of the projectors 301. Either way, the data 368 can originate at a server and/or a computing device and/or an image generator and the like accessible via the network through the access point 363, for example operated by an entity which controls and/or deploys the projectors 301.

Alternatively, in other implementations, the respective data 368 is provisioned (e.g. at the block 201 of the method 200) at a respective memory of each of the projectors 301 by uploading the respective data 368 to each projector 301 using a temporary hardware connection (e.g. via the ports 340, and the like). Such provisioning can occur when the projectors 301 are installed in the location where they are to be projecting and/or in a factory and/or prior to transporting to the location where they are to be projecting.

Each set of data 368 is similar to the data 108 described above, however each respective set of data 368 is configured for the projector 301 to which the data 368 is transmitted. For example, the data 368-1 includes images (e.g. frames and/or subframes) to be projected by the projector 301-1, as well as respective times that each of the images (e.g. frame times and/or subframe times), and the data 368-2 includes images (e.g. frames and/or subframes) to be projected by the projector 301-2, as well as respective times that each of the images (e.g. frame times and/or subframe times). The two sets of times in each set of data 368 can be the same and/or similar, but the image data for each is generally respective to the projector 301. For example, as the projectors 301 are arranged to project tiled images, the image data in each set of data 368 includes the respective portions of the tiled images to be projected by each of the projectors 301, and/or respective data indicating which portion of the images are to be projected by each of the projectors 301. While the times in each set of data 368 can, in some implementations, be the same, in other implementations, the times in each set of data 368 can be different, however it is assumed that the times in each set of data 368 are synchronized to an atomic clock, as described above.

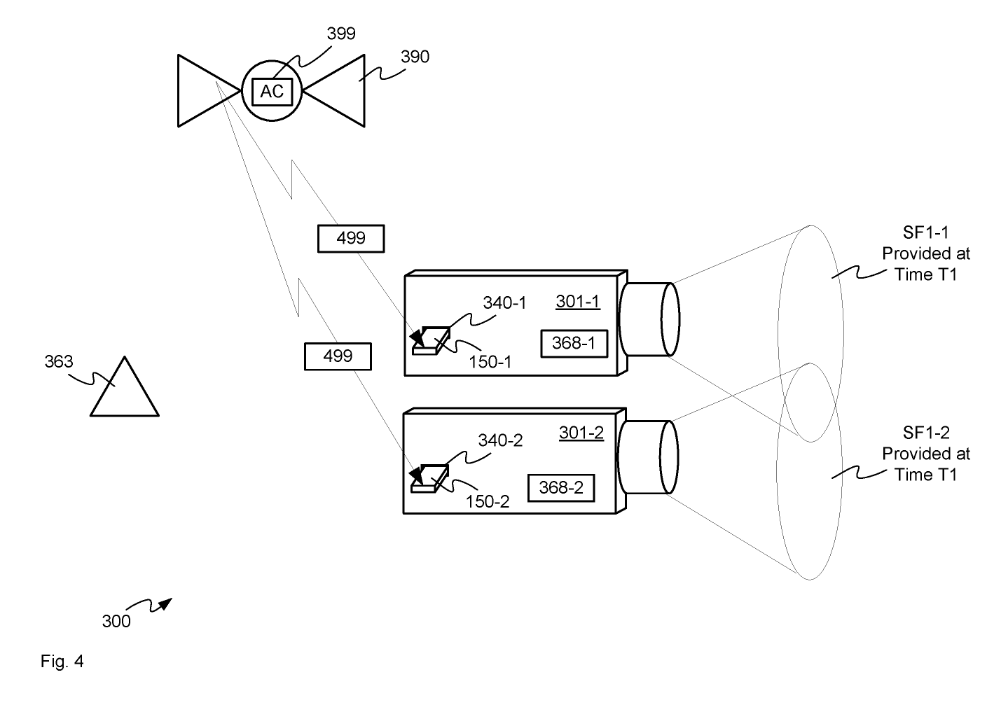

As further depicted in FIG. 3, the system 300 further comprises at least one satellite 390 that comprises an atomic clock (AC) 399 which includes, but is not limited to GPS satellites and/or GLONASS satellites. With attention next directed to FIG. 4, which is similar to FIG. 3, with like elements having like numbers, and with respective data 368 schematically depicted at each of the projectors 301, each the LD devices 150 communicate with the at least one satellite 390 to synchronize each respective AAC 105 with the AC 399 at the at least one satellite 390, for example by receiving synchronization data 499 from the at least one satellite 390, the synchronization data 499 comprising, for example, a current time of the AC 399. Indeed, the synchronization data 499 is similar and/or the same as data received at each of LD devices 150 when each of LD devices 150 is determining a respective location using their GPS and/or GLONASS functionality.

In some implementations, respective AAC 105 at each of the LD device 150 can be synchronized to atomic clocks on different satellites as long as the atomic clocks on the different satellites are themselves synchronized, as is the case with GPS satellites and/or GLONASS satellites.

Alternatively, each respective AAC 105 at each of the LD devices 150 can be synchronized to an atomic clock located at a factory and/or other locations and/or an atomic clock transported to the location where the projectors 301 are to be projecting, without the use of the satellites; indeed, in these implementations, the LD devices 150 are optional. In other words, the method 200 is implemented at each of the projectors as long a respective AAC 105 at each projector 301 is synchronized with an atomic clock (e.g. the same atomic clock and/or different atomic clocks, assuming the different atomic clocks are themselves synchronized).

With further reference to FIG. 4, assuming that the set of data 368-1 includes a first subframe SF1-1 to be projected at a time T1, according to the respective AAC 105 of the LD device 150-1, synchronized with the AC 399 at the satellite 390 via the synchronization data 499, and assuming that the set of data 368-2 includes a first subframe SF1-2 to be projected at the same time Ti, according to the respective AAC 105 of the LD device 150-2, synchronized with the AC 399 at the satellite 390 via the synchronization data 499, then each of the projectors 301 automatically begins projecting (e.g. at the block 203 of the method 200) a respective subframe SF1 at the same time T1, without any further signal to begin projecting, and/or without hardware connections therebetween, and/or without wireless signals that begin the projection. Each respective projector 301 proceeds to project the images in the respective data 368 according to the respective times.

In the example implementations of FIG. 3 and FIG. 4 the projectors 301 can each be replaced with flat panel displays, and the like, such that at the block 203 of the method 200, the flat panel displays begin rendering each respective subframe SF1 at the same time T1, rather than projecting.

Furthermore, while only two projectors 301 are depicted in the system 300, the system 300 can comprise more than two projectors and/or other image generation devices. Indeed, as the content to be provided is uploaded to each of the image generation devices e.g. projectors 301 and/or other display devices), using either a wireless link to the access point 363 and/or a via a temporary hardware connection to each of the image generation devices, and as synchronization of providing images and/or generating content by each of the image generation devices occurs using synchronized atomic accuracy clocks located at each of the image generation devices, the methods described herein can be referred to as distributed wireless methods to synchronize display and image generation devices and leverage pre-shared content (as the data 108 and/or the data 368) for lightweight network synchronization of the content as provided by the image generation devices.

Furthermore, the methods described herein are scalable to any number of image generation devices, and can also be used with real-time generated content, as described above.

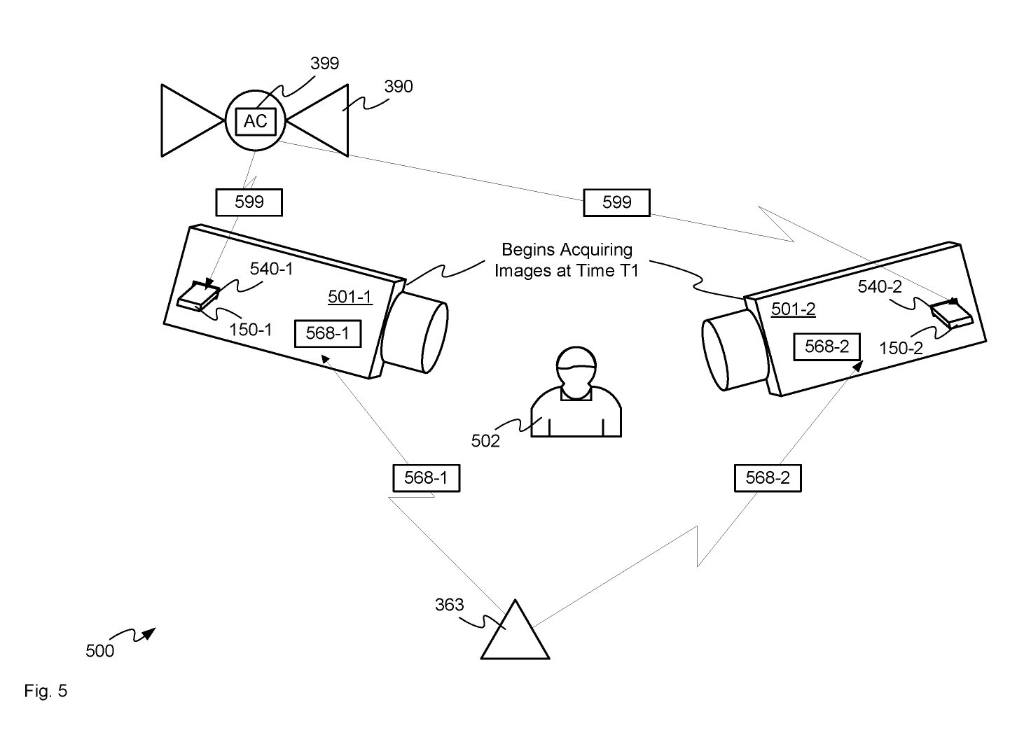

Attention is next directed to FIG. 5 which depicts a system 500 that is substantially similar to the system 300, with like elements having like numbers, however the projectors 301 have been replaced with two cameras 501-1, 501-2 (collectively referred to, hereafter as the cameras 501, and generically as a camera 501), each similar to device 101, assuming that the image component 103 comprises a camera imaging component, as described above. Hence, each of the cameras 501 includes a controller (not depicted) similar to controller 120 which is executing an application similar to application 130, and hence each of the cameras 501 is implementing the method 200. It is assumed in the system 500 that the cameras 501 are arranged to capture images of a scene 502 (e.g. as depicted that includes a person) from different angles.

It is further assumed that each of the two cameras 501 comprise respective hardware port 540-1, 540-2 (collectively referred to, hereafter as the ports 540, and generically as a port 540), each similar to the hardware port 140. For example, each of the ports 540 can comprise a USB port. At each of the ports 540, each camera 540 has received therein a respective LD device 150 as described above, which includes a respective AAC 105 (not depicted, but assumed to be at each of respective LD device 150). While other internal components of the cameras 501 are not depicted, they are nonetheless assumed to be present.

In any event, in the system 500, each of the cameras 501 receives (e.g. at the block 201 of the method 200) respective data 568-1, 568-2 from the access point 363 (and/or a hardware source as described above), that includes at least a time at which each of the cameras 501 is to begin acquiring images of the scene 502. Each of the LD devices 150 further synchronizes their respective AAC 105 with an atomic clock, such as the atomic clock 399 of the at least one satellite 390 via receipt of synchronization data 599 (similar to synchronization data 499). Assuming that each respective set of data 568-1 568-2 includes a time T1 at which the cameras 501 are to begin acquiring images, each of the cameras 501 then begin acquiring images (e.g. at the block 203 of the method 200) at the time T1. However, the times that each camera 501 is to begin acquiring images can be different. Similarly, each respective set of data 568-1 568-2 can includes a time at which the cameras 501 are to stop acquiring images, and each of the cameras 501 then stop acquiring images at that time; however, the times that each camera 501 is to stop acquiring images can be different. The images acquired at each of the cameras 501 can be stored at a respective memory and/or uploaded to a server, and the like, via the access point 363. Hence, the techniques used for generation of synchronized content and/or providing images, can also be applied to acquisition of images using cameras.

The devices and methods of the present specification can enable distributed, synchronized providing of images with minimal latency, for example by eliminating synchronization via ongoing wireless signalling and/or hardware. In particular, the devices and methods of the present specification provide distributed wireless technique to synchronize multiple displays and/or image generation devices and/or hardware. Content can be pre-rendered and stored locally with each image generation device and/or display, and/or the content may be generated, for example in real time. The methods of the present specification are scalable to large numbers of displays and/or image generation devices. The devices and methods provided in the present specification further have a low latency for synchronization, as compared to synchronization via ongoing wireless signalling and/or hardware. In some implementations, the latency may be less than that of a video frame period of the content, which can enable the devices and methods provided in the present specification suitable for use interactive applications. For example, the time to synchronize the projectors 301 and/or the time to synchronize the cameras 501 is generally the time to synchronize the respective atomic accuracy clocks with the atomic clock of a satellite, which can be performed once and/or periodically, and which can be generally less than the time of a video frame period of content. The devices and methods provided in the present specification may further be robust against varying frame rates, types of display equipment, types of image generation hardware, video protocols, and/or video distribution schemes, as the synchronization using the atomic accuracy clocks is relatively simple as compared to synchronization via ongoing wireless signalling and/or hardware.

Those skilled in the art will appreciate that in some implementations, the functionality of the device 101 can be implemented using pre-programmed hardware or firmware elements (e.g., application specific integrated circuits (ASICs), electrically erasable programmable read-only memories (EEPROMs), etc.), or other related components. In other implementations, the functionality of d the device 101 can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative implementations and modifications possible, and that the above examples are only illustrations of one or more implementations. The scope, therefore, is only to be limited by the claims appended hereto.

What is claimed is:

1. An image device comprising:
an image component configured to one of provide or acquire images;
an atomic accuracy clock synchronizable with an atomic clock;
an interface configured to receive data indicative of one or more times for one of providing or acquiring the images; and
a controller configured to control the image component to provide or acquire the images at the one or more times synchronized with the atomic accuracy clock.

2. The image device of claim 1, wherein the image component comprises one or more of a display device and a projector configured to provide the images; the data further comprises the images to be provided, and one or more times for providing the images; and the controller is further configured to control the image component to provide the images at the one or more times synchronized with the atomic accuracy clock.

3. The image device of claim 2, wherein the images to be provided comprise one or more of frames and subframes, and the one or more times comprises one or more of frame times and subframe times at which respective frames and subframes are to be provided, synchronized with the atomic accuracy clock.

4. The image device of claim 1, wherein the image component comprises one or more of a camera, a video camera, and a cinema-quality digital movie camera configured to acquire the images; and the controller is further configured to control the image component to acquire the images at the one or more times synchronized with the atomic accuracy clock.

5. The image device of claim 1, further comprising a location determining device comprising the atomic accuracy clock, the location determining device configured to:
communicate with one or more location-determining satellites comprising the atomic clock; and synchronize the atomic accuracy clock with the atomic clock.

6. The image device of claim 5, wherein the location determining device comprises one or more of a satellite-based location determining device, a GPS (Global Positioning System) device and a GLONASS (Globalnaya Navigazionnaya Sputnikovaya Sistema) device.

7. The image device of claim 1, further comprising: a mobile satellite-based location determining device; and a hardware port configured to removably receive the mobile satellite-based location determining device, the mobile satellite-based location determining device comprising the atomic accuracy clock.

8. An method comprising:
at an image device comprising: an image component configured to one of provide or acquire images; an atomic accuracy clock synchronizable with an atomic clock; an interface configured to receive data indicative of one or more times for one of providing or acquiring the images; and a controller,
receiving, at the controller, using the interface, the data indicative of the one or more times for one of providing or acquiring the images; and
controlling, using the controller, the image component to provide or acquire the images at the one or more times synchronized with the atomic accuracy clock.

9. The method of claim 8, wherein the image component comprises one or more of a display device and a projector configured to provide the images; the data further comprises the images to be provided, and one or more times for providing the images; and the method further comprises controlling, at the controller, the image component to provide the images at the one or more times synchronized with the atomic accuracy clock.

10. The method of claim 9, wherein the images to be provided comprise one or more of frames and subframes, and the one or more times comprises one or more of frame times and subframe times at which respective frames and subframes are to be provided, synchronized with the atomic accuracy clock.

11. The method of claim 8, wherein the image component comprises one or more of a camera, a video camera, and a cinema-quality digital movie camera configured to acquire the images; and the method further comprises controlling, at the controller, the image component to acquire the images at the one or more times synchronized with the atomic accuracy clock.

12. The method of claim 8, wherein the image device further comprises a location determining device comprising the atomic accuracy clock, the location determining device configured to: communicate with one or more location-determining satellites comprising the atomic clock; and synchronize the atomic accuracy clock with the atomic clock.

13. The method of claim 12, wherein the location determining device comprises one or more of a satellite-based location determining device, a GPS (Global Positioning System) device and a GLONASS (Globalnaya Navigazionnaya Sputnikovaya Sistema) device.

14. The method of claim 8, wherein the image device further comprises: a mobile satellite-based location determining device; and a hardware port configured to removably receive the mobile satellite-based location determining device, the mobile satellite-based location determining device comprising the atomic accuracy clock.

15. A non-transitory computer-readable medium storing a computer program, wherein execution of the computer program is for:
at an image device comprising: an image component configured to one of provide or acquire images; an atomic accuracy clock synchronizable with an atomic clock; an interface configured to receive data indicative of one or more times for one of providing or acquiring the images; and a controller,
receiving, at the controller, using the interface, the data indicative of the one or more times for one of providing or acquiring the images; and
controlling, using the controller, the image component to provide or acquire the images at the one or more times synchronized with the atomic accuracy clock.
